(19) United States
(12) Patent Application Publication
(10) Pub. No.: US 2025/0274855 A1
(43) Pub. Date: Aug. 28, 2025

(54) COMMUNICATION DEVICE AND COMMUNICATION CONTROL METHOD

(71) Applicant: HONDA MOTOR CO., LTD., Tokyo (JP)

(72) Inventors: Shinichi Kobayashi, Tokyo (JP); Koki Hirobuchi, Tokyo (JP); Daiki Kawase, Tokyo (JP); Ryosuke Asafuji, Tokyo (JP); Takumi Fukuda, Tokyo (JP)

(21) Appl. No.: 19/016,404

(22) Filed: Jan. 10, 2025

(30) Foreign Application Priority Data
Feb. 27, 2024 (JP) 2024-027410

(51) Int. Cl. H04W 48/20; H04L 41/22; H04M 1/72409; H04M 1/72469

(52) U.S. Cl. CPC H04W 48/20; H04L 41/22; H04M 1/724098; H04M 1/72469

(57) ABSTRACT

A communication device includes: a communication unit configured to perform wireless communication; an access point detection unit configured to detect access points capable of communication connection with the communication unit; and a communication control unit configured to display an access point information image on a display device when communication between the communication unit and a communication terminal is performed in a first frequency band, the access point information image presenting information on the access points detected by the access point detection unit, with a first access point capable of communication connection in the first frequency band being presented differently from a second access point capable of communication connection in a second frequency band.

### INCORPORATION BY REFERENCE

The present application claims priority under 35 U.S.C. § 119 to Japanese Patent Application No. 2024-027410 filed on Feb. 27, 2024. The content of the application is incorporated herein by reference in its entirety.

### BACKGROUND OF THE INVENTION

### Field of the Invention

The present invention relates to a communication device and a communication control method.

### Description of the Related Art

In the past, a wireless communication system has been proposed, which determines the radio wave condition in the area where an on-board device and a communication terminal outside the vehicle are located, and notifies the on-board device and the communication terminal of a channel and a frequency that allow direct communication between them (see Japanese Patent Laid-Open No. 2009-17101, for example).

If a communication device used in a mobile object such as a vehicle has a capability to simultaneously communicate with multiple communication targets in different frequency bands, the communication device can, for example, communicate with a communication terminal in a first frequency band and with an access point outside the mobile object in a second frequency band. However, when the communication device and the access point attempt to communicate in the first frequency band while the communication device and the communication terminal are communicating in the same frequency band, inconveniently, the communication between the communication device and the communication terminal is interrupted or the frequency is changed by instructions for connection with the access point without permission because the frequency bands overlap.

The present invention has been made in view of such background, and the object of the invention is to provide a communication device and a communication control method that can prevent interruption of communication with a communication terminal due to connection with an access point and can prevent change of the frequency by instructions for connection with the access point without permission during the communication with the communication terminal in a mobile object.

### SUMMARY OF THE INVENTION

As a first aspect to achieve the aforementioned object, a communication device is provided, which is used in a mobile object and includes: a communication unit configured to perform wireless communication with communication targets in a first frequency band or a second frequency band; an access point detection unit configured to detect access points capable of communication connection with the communication unit; and a communication control unit configured to control communication between the communication unit and a communication terminal and communication between the communication unit and the access points, and to display an access point information image on a display device used in the mobile object when the communication between the communication unit and the communication terminal is performed in the first frequency band, the access point information image presenting information on the access points detected by the access point detection unit, with a first access point capable of communication connection in the first frequency band being presented differently from a second access point capable of communication connection in the second frequency band.

In the above communication device, the communication control unit may be further configured to display the access point information image on the display device when the communication between the communication unit and the communication terminal is performed in the first frequency band and the communication control unit recognizes an operation to connect the communication unit and the access points by an occupant of the mobile object.

In the above communication device, the communication control unit may be further configured to interrupt the communication between the communication unit and the communication terminal in the first frequency band when the communication between the communication unit and the communication terminal is performed in the first frequency band and the communication control unit recognizes an operation to connect the communication unit and the access points by the occupant, and the access point detection unit may be further configured to detect the access points capable of communication connection with the communication unit by performing communication in the first frequency band and the second frequency band while the communication between the communication unit and the communication terminal is interrupted.

In the above communication device, the communication control unit may be further configured to start communication between the communication unit and the second access point in the second frequency band and resume the communication between the communication unit and the communication terminal in the first frequency band when the communication control unit recognizes an operation to connect to the second access point by an occupant of the mobile object in response to display of the access point information image on the display device.

In the above communication device, the communication control unit may be further configured to output a communication unavailability announcement that communication with the terminal device becomes unavailable from an announcement device used in the mobile object when the communication control unit recognizes an operation to connect to the first access point by an occupant of the mobile object in response to display of the access point information image on the display device.

In the above communication device, the communication control unit may be further configured to output a recommended frequency band announcement recommending connection with the second access point from an announcement device used in the mobile object when the communication control unit recognizes an operation to connect to the first access point by an occupant of the mobile object in response to display of the access point information image on the display device.

In the above communication device, the communication control unit may be further configured to display on the display device as the access point information image an image in which only information on the second access point is presented and information on the first access point is hidden.

In the above communication device, the communication control unit may be further configured to display on the display device as the access point information image an image in which information on the second access point is presented preferentially over information on the first access point.

In the above communication device, the communication control unit may be further configured to change a display style of the access point information image according to an operation to set the display style of the access point information image by an occupant of the mobile object.

As a second aspect to achieve the aforementioned object, a communication control method is provided, which is performed by a communication device used in a mobile object and including a communication unit configured to perform wireless communication with communication targets in a first frequency band or a second frequency band, the method including: an access point detection step of detecting access points capable of communication connection with the communication unit; and a communication control step of controlling communication between the communication unit and a communication terminal and communication between the communication unit and the access points, and displaying an access point information image on a display device used in the mobile object when the communication between the communication unit and the communication terminal is performed in the first frequency band, the access point information image presenting information on the access points detected in the access point detection step, with a first access point capable of communication connection in the first frequency band being presented differently from a second access point capable of communication connection in the second frequency band.

The communication device and the communication control method described above can prevent interruption of communication with a communication terminal due to connection with an access and can prevent change of the frequency by instructions for connection with the access point without permission during the communication with the communication terminal in a mobile object.

### BRIEF DESCRIPTION OF THE DRAWINGS

FIG. 1 is an illustration of a configuration of a vehicle equipped with a communication device;

FIG. 2 is a block diagram of the communication device;

FIG. 3 is an illustration of a mode of connection of a communication target that is a smartphone and an external access point;

FIG. 4 is the first flowchart of a process of connection with an external access point;

FIG. 5 is the second flowchart of the process of connection with an external access point;

FIG. 6 is an illustration of a first example display of an access point information image; and

FIG. 7 is an illustration of a second example display of the access point information image.

### DETAILED DESCRIPTION OF THE INVENTION

### 1. Configuration of Vehicle Equipped With Communication Device

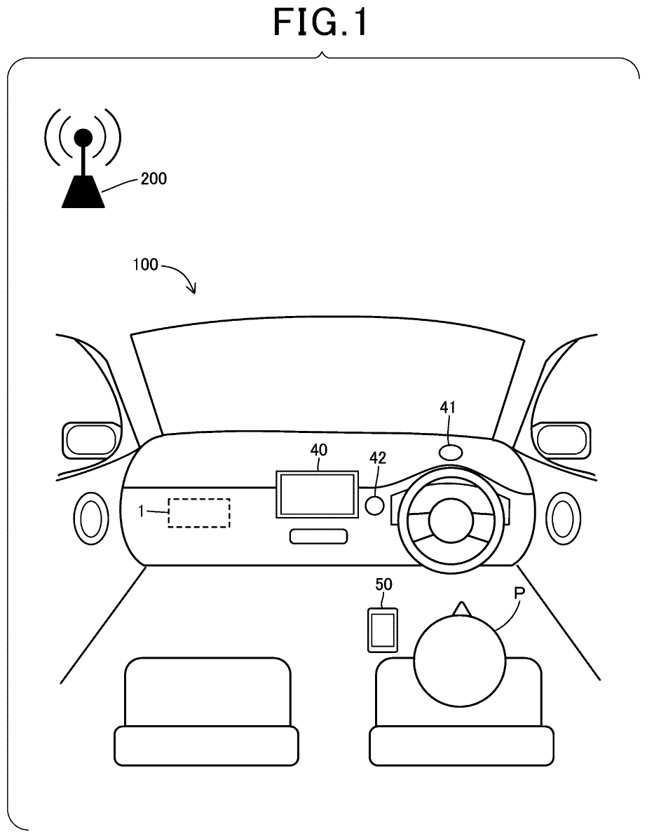

The configuration of a vehicle 100 equipped with a communication device 1 in the present embodiment will be described with reference to FIG. 1. The communication device 1 is configured as part of the functionality of an on-board device installed in the vehicle 100 and is connected to a display device 40, an on-board microphone 41, and an on-board speaker 42. The vehicle 100 corresponds to a mobile object in this disclosure. The display device 40 is a touch panel with a touch sensor arranged on the surface of a flat display such as an LCD panel and an OLED panel. The display device 40 and the on-board speaker 42 correspond to an announcement device in this disclosure.

The communication device 1 performs wireless communication in the 5 GHz band with a smartphone 50 used by an occupant P of the vehicle 100 and wireless communication in the 5 GHz or 2.4 GHz band with an external access point 200 located around the vehicle 100 and connected to a communication network 210. The communication device 1 performs wireless communication in compliance with, for example, the Wi-Fi® standard. The 5 GHz band corresponds to a first frequency band in this disclosure, and the 2.4 GHz band corresponds to a second frequency band in this disclosure. The first frequency band in this disclosure may be a frequency band other than the 5 GHz band, and the second frequency band in this disclosure may be a frequency band other than the 2.4 GHz band. In the following, the external access point is also referred to as an external AP.

The smartphone 50 corresponds to a communication terminal having a processor in this disclosure. The communication terminal in this disclosure includes a cell phone, tablet terminal, etc., in addition to a smartphone. The communication device 1 detects connectable external APs 200, displays information on the external APs 200 on the display device 40, and determines to which external AP 200 the communication device 1 connects according to touch operation on the display device 40 by the occupant P.

### 2. Configuration of Communication Device

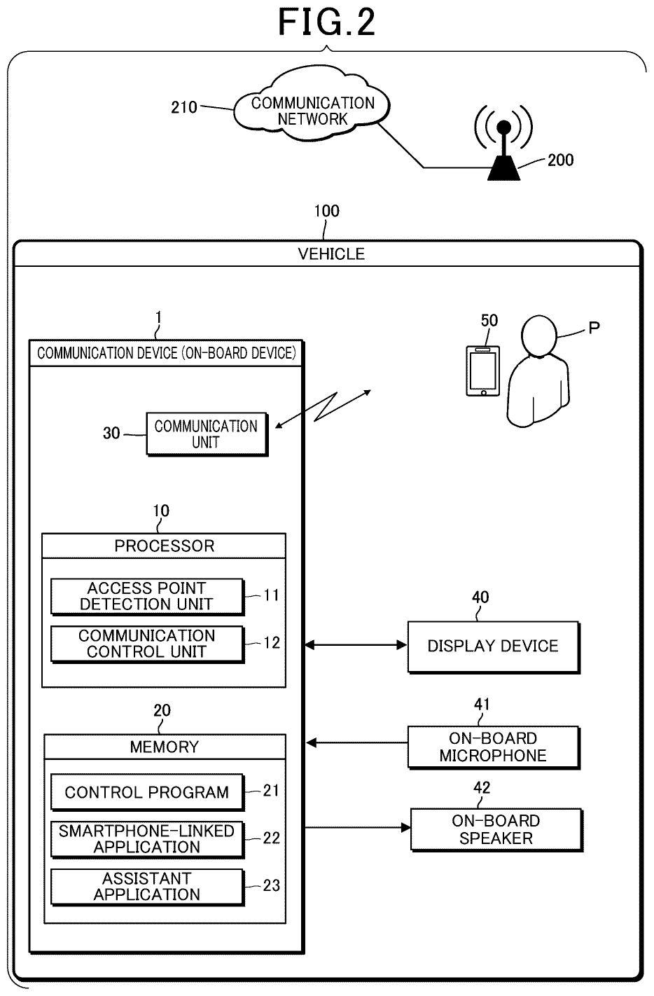

The configuration of the communication device 1 will be described with reference to FIG. 2. The communication device 1 is a control unit including a processor 10, a memory 20, and a communication unit 30. The communication unit 30 includes a transmitter and a receiver and performs wireless communication in the 5 GHz band with the smartphone 50 and wireless communication in the 5 GHz or 2.4 GHz band with the external AP 200.

The memory 20 stores a control program 21 for the communication device 1, a smartphone-linked application program 22, and an assistant application program 23. The smartphone-linked application enables applications running on the smartphone (e.g., a car navigation application) to be used on the display device 40. The assistant application enables the use of a virtual assistant that supports speech-based operation of the vehicle 100 by the occupant P. The processor 10 functions as an access point detection unit 11 and a communication control unit 12 by reading and executing the program 21.

The process performed by the access point detection unit 11 corresponds to the access point detection step in the communication control method of the present disclosure, and the process performed by the communication control unit 12 corresponds to the communication control step in the communication control method of the present disclosure.

The access point detection unit 11 detects external APs 200 that exist around the vehicle 100 and can be connected to the communication unit 30. The communication control unit 12 controls wireless communication between the communication unit 30 and communication targets (in the examples in FIGS. 1 and 2, the smartphone 50 and the external AP 200).

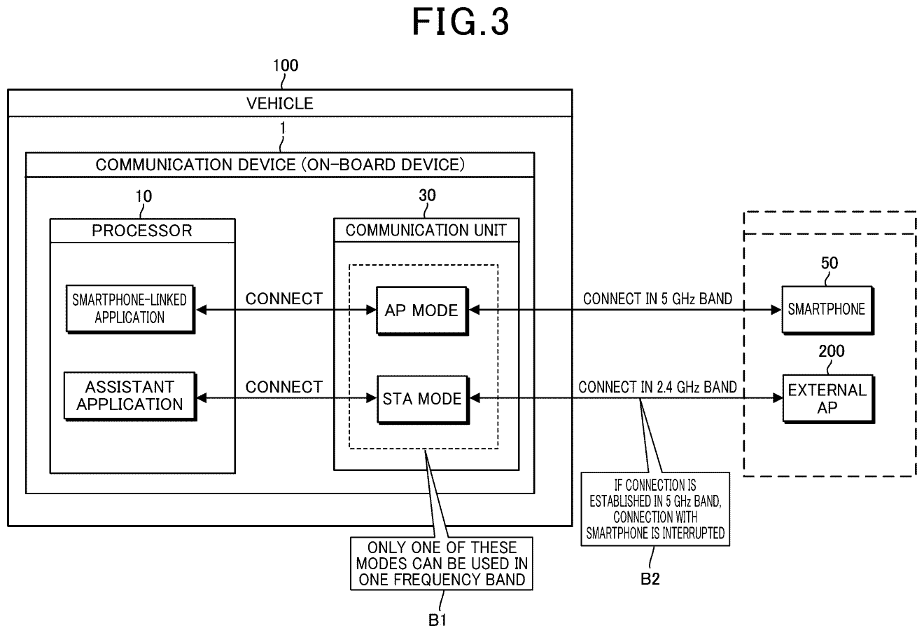

The processor 20 executes the smartphone-linked application program 22 to enable the use of the smartphone-linked application and executes the assistant application program 23 to enable the use of the assistant application, as shown in FIG. 3. The smartphone-linked application connects the communication unit 30 and the smartphone 50 in AP mode (access point mode) in the 5 GHZ band. The assistant application connects the communication unit 30 and the external AP 200 in STA mode (station mode) in the 2.4 GHz or 5 GHz band. FIG. 3 illustrates a situation where the communication unit 30 is connected to the external AP 200 in the 2.4 GHz band.

As shown in the bubble B1, the communication unit 30 can use only one of AP mode and STA mode in the same frequency band. Thus, as shown in FIG. 3, when the occupant P performs an operation to connect to the external AP 200 in STA mode in the 5 GHz band while the communication unit 30 and the smartphone 50 are connected in AP mode in the 5 GHz band, inconveniently, the communication between the communication unit 30 and the smartphone 50 is cut off and the smartphone-linked application that has been used is no longer usable.

The communication device 1, therefore, performs the following connection process with the external AP 200 to prevent the communication between the communication unit 30 and the smartphone 50 from being interrupted due to overlap between the frequency bands used for connection with the smartphone 50 and for connection with the external AP 200.

### 3. Connection Process With External AP

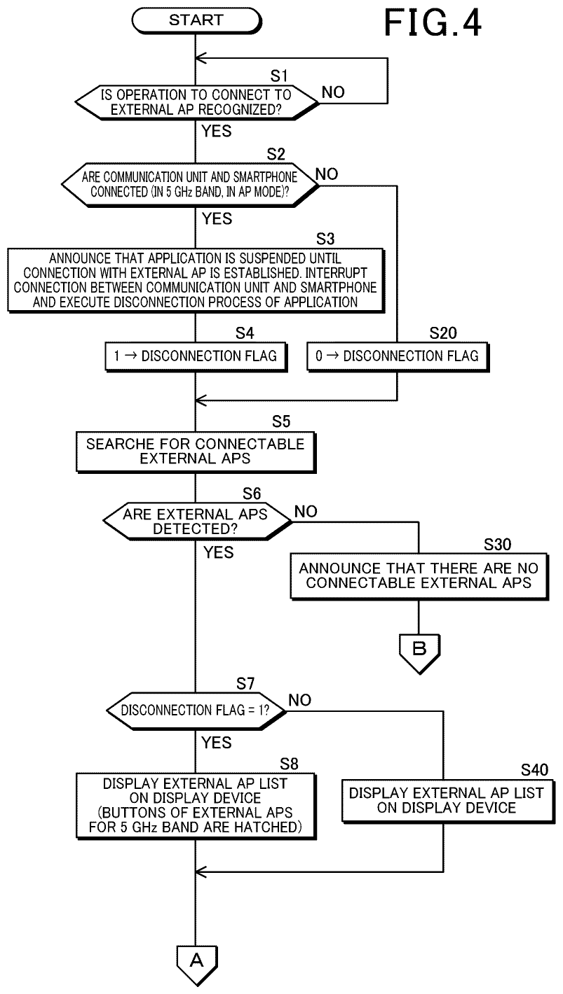

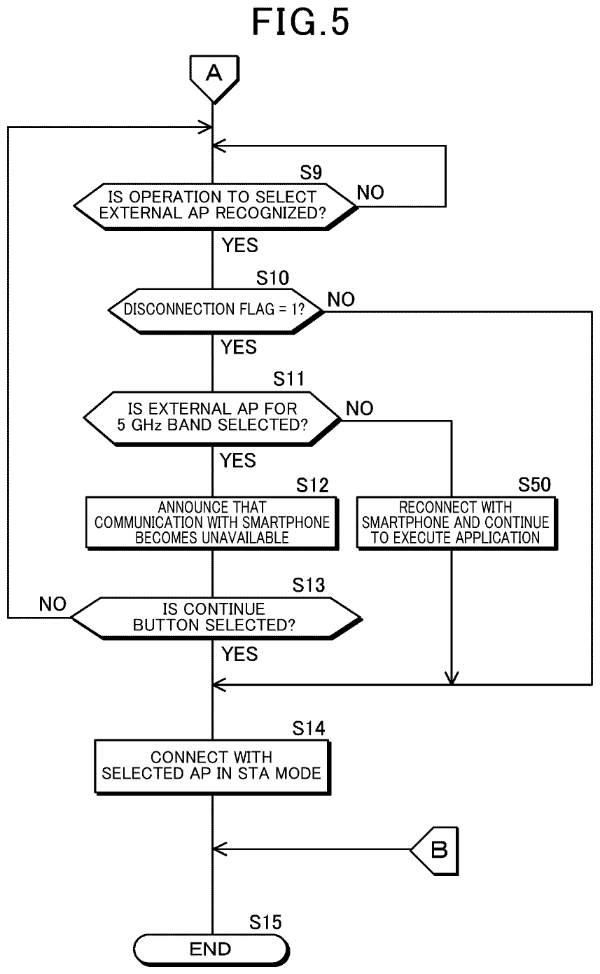

The flowchart shown in FIGS. 4 and 5 describes the procedure of the connection process with the external AP 200 executed by the access point detection unit 11 and the communication control unit 12. In step S1 in FIG. 4, when the communication control unit 12 recognizes an operation to connect to the external AP 200 (e.g., an operation of the communication setting menu displayed on the display device 40) by the occupant P, the process proceeds to step S2.

In step S2, the communication control unit 12 determines whether or not the communication unit 30 and the smartphone 50 are connected (in AP mode in the 5 GHz band). The communication control unit 12 advances the process to step S3 if the communication unit 30 and the smartphone 50 are connected, or to step S20 if the communication unit 30 and the smartphone 50 are not connected.

In step S3, the communication control unit 12 announces to the occupant P that the application (smartphone-linked application) is suspended until the connection with the external AP 200 is established, either by display on the display device 40 or by audio output from the on-board speaker 42. The communication control unit 12 also interrupts the connection between the communication unit 30 and the smartphone 50 and executes the disconnection process of the application. In the subsequent step S4, the communication control unit 12 sets a disconnection flag, which indicates whether the connection with the smartphone 50 is interrupted or not, to “1” (disconnected) and advances the process to step S5. In step S20, the communication control unit 12 sets the disconnection flag to “0” (not disconnected) and advances the process to step S5.

In step S5, the access point detection unit 11 searches for external APs 200 that can be connected to the communication unit 30 based on the radio wave reception condition of the communication unit 30 in the 2.4 GHz and 5 GHz bands. In the subsequent step S6, the access point detection unit 11 advances the process to step S7 if the access point detection unit 11 detects external APs 200 that can be connected to the communication unit 30, or to step S30 if the access point detection unit 11 does not detect external APs 200 that can be connected to the communication unit 30.

In step S30, the communication control unit 12 displays on the display device an announcement image 40 indicating that there are no connectable external APs 200, and advances the process to step S13 in FIG. 5. In step S7, the communication control unit 12 determines whether the disconnection flag is “1” or not and advances the process to step S8 if the disconnection flag is “1” or to step S40 if the disconnection flag is “0.”

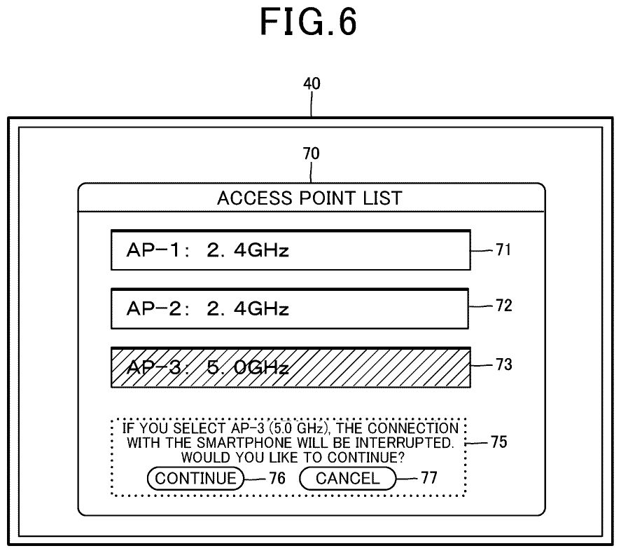

In step S8, the communication control unit 12 displays on the display device 40 an access point information image 70 presenting a list of information on the external APs 200 detected by the access point detection unit 11 (AP-1, AP-2, and AP-3 are shown in the figure by way of example), as shown in FIG. 6, and advances the process to step S9 in FIG. 5. The access point information image 70 presents information on AP-1 to AP-3 by means of selection buttons 71 to 73, and the communication control unit 12 receives selection of one of the external APs 200 based on touch operation of one of the selection buttons by the occupant P.

In the access point information image 70, the button 73 for AP-3, which supports communication connection in the 5.0 GHz band, is hatched to make the button 71 for AP-1 and the button 72 for AP-2, which support communication connection in the 2.4 GHz band, more viewable than the button 73 for AP-3. In this way, information on external APs 200 (AP-1 and AP-2 in this example) that support communication connection in the 2.4 GHz band, which do not overlap with the 5 GHz band used for the connection with the smartphone 50, is presented preferentially over and differently from information on external APs 200 (AP-3 in this example) that support communication connection in the 5 GHz band, thereby encouraging the occupant P to select an external AP 200 that supports the 2.4 GHz band to prevent the connection with the smartphone 50 from being interrupted due to overlap between the frequency bands used.

In contrast, in step S40, the communication control unit 12 displays on the display device 40 an access point information image 80 that, equally and without distinction, presents buttons 81 and 82 indicating information on the external APs 200 that support the 2.4 GHz band and a button 83 indicating information on the external AP 200 that supports the 5 GHz band, as shown in FIG, 7, and advances the process to step S13 in FIG. 5.

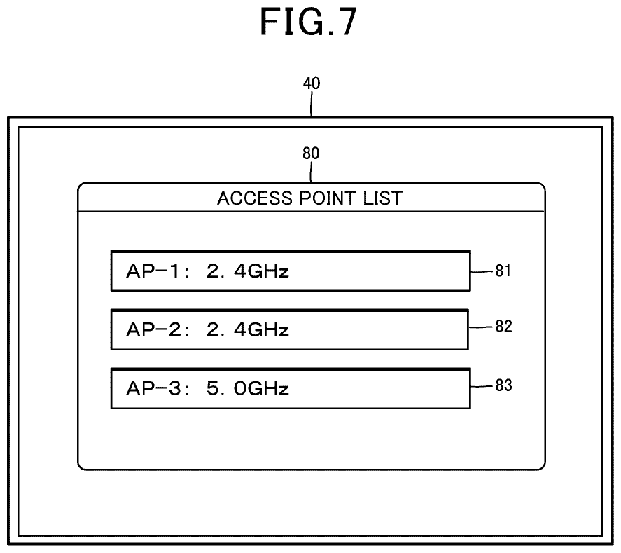

In step S9 in FIG. 5, the communication control unit 12 advances the process to step S10 when it recognizes an operation to select one of the external APs 200 in the access point information image 70 (see FIG. 6) or the access point information image 80 (see FIG. 7) by the occupant P. In step S10, the communication control unit 12 determines whether the disconnection flag is “1” or not and advances the process to step S11 if the disconnection flag is “1” or to step S14 if the disconnection flag is “b 0.”

In step S11, the communication control unit 12 determines whether or not an external AP 200 that supports communication connection in the 5 GHz band is selected by the occupant P. The communication control unit 12 advances the process to step S12 if an external AP 200 that supports communication connection in the 5 GHz band is selected, and to step S50 if an external AP 200 that does not support communication connection in the 5 GHz band (but supports communication connection in the 2.4 GHz band) is selected.

In step S12, as shown in FIG. 6, the communication control unit 12 displays on the display device 40 a communication unavailability announcement image 75 announcing that the connection with the smartphone 50 is interrupted and communication with the smartphone 50 becomes unavailable if AP-3, which is an external AP 200 that supports communication connection in the 5 GHz band, is selected. The announcement image 75 includes a continue button 76 and a cancel button 77.

In step S13, the communication control unit 12 determines whether the continue button 76 is selected or not. The communication control unit 12 then advances the process to step S14 if the continue button 76 is selected, or to step S14 if the continue button 76 is not selected (if the cancel button 77 is selected).

In step S50, because the occupant P has selected an external AP 200 that supports communication connection in the 2.4 GHz band and thus the frequency band used with the smartphone 50 does not overlap, the communication control unit 12 reconnects the communication unit 30 and the smartphone 50 (reconnects in AP mode in the 5 GHZ band) and continues to execute the smartphone-linked application, and advances the process to step S14. In step S14, the communication control unit 12 connects the external AP 200 selected by occupant P and the communication unit 30 in STA mode.

### 4. Alternative Embodiments

In the above embodiment, the vehicle 100 is shown as an example of the mobile object in which the communication device 1 is used, but the mobile object in this disclosure may be any other type of mobile object in which occupants use wireless communication, such as an aircraft and a ship.

In the above embodiment, as an access point information image that presents information on external APs 200 that support communication connection in a second frequency band that does not overlap with a first frequency band used for communication between the communication unit 30 and the smartphone 50 differently from information on external APs 200 that support communication connection in the first frequency band, the display image 70 is shown, in which information on the external AP 200 that uses the first frequency band is hatched, as shown in FIG. 6.

As alternative embodiments of such a display image, for example, an access point information image may be displayed in the display styles according to the following variants 1 through 5.
Variant 1—Only information on external APs 200 that support communication connection in the second frequency band is presented, and information on external APs 200 that support communication connection in the first frequency band is hidden.
Variant 2—As shown in FIG. 6, the order of presenting information on external APs 200 is as shown in FIG. 6, i.e., information on external APs 200 that support communication connection in the second frequency band is presented first from the top, followed by information on external APs 200 that support communication connection in the first frequency band.
Variation 3—The brightness or luminance of display of information on external APs 200 that support communication connection in the second frequency band is higher than that of information on external APs 200 that support communication connection in the first frequency band.
Variant 4—information on external APs 200 that support communication connection in the second frequency band and information on external APs 200 that support communication connection in the first frequency band are presented in different colors.
Variant 5—information on external APs 200 that support communication connection in the second frequency band is presented larger in size than information on external APs 200 that support communication connection in the first frequency band.

The display style of the access point information image may be changed to one of the display styles shown in FIG. 6 and the above variants 1 to 5 according to an operation to set the display style of the access point information image by the occupant P.

In the above embodiment, in step S12 in FIG. 5, the communication control unit 12 displays on the display device 40 a communication unavailability announcement image 75 announcing that communication with the smartphone 50 becomes unavailable if an external AP 200 that supports the 5 GHz band is selected by the occupant P. As an alternative embodiment, instead of or together with the communication unavailability announcement image 75, a recommended frequency band announcement image may be displayed on the display device 40, which recommends connection with an external AP 200 that supports communication connection in the 2.4 GHz band, which does not overlap with the frequency band used for the smartphone 50. The communication unavailability announcement and the recommended frequency announcement may be performed by audio output from the on-board speaker 42.

In the above embodiment, the communication device 1 installed in the vehicle 100 is shown, but the communication device in the present disclosure may also be a portable communication device that is carried and used in a mobile object. In this case, the communication device may be a display-integrated communication device including a display device.

FIG. 2 is a schematic diagram illustrating the configuration of the communication device 1 divided according to the main processing features to facilitate understanding of the present invention, but the configuration of the communication device 1 may be divided in different ways. The processing of each component may be performed by a single hardware unit or by multiple hardware units. The process executed by each component shown in FIGS. 4 and 5 may be performed by a single program or by multiple programs.

### 5. Configurations Supported by Above Embodiment

The above embodiment is a specific example of the following configurations.

(Configuration 1) A communication device used in a mobile object, including: a communication unit configured to perform wireless communication with communication targets in a first frequency band or a second frequency band; an access point detection unit configured to detect access points capable of communication connection with the communication unit; and a communication control unit configured to control communication between the communication unit and a communication terminal and communication between the communication unit and the access points, and to display an access point information image on a display device used in the mobile object when the communication between the communication unit and the communication terminal is performed in the first frequency band, the access point information image presenting information on the access points detected by the access point detection unit, with a first access point capable of communication connection in the first frequency band being presented differently from a second access point capable of communication connection in the second frequency band.

With the communication device in configuration 1, an access point information image is displayed on the display device, which presents information on access points capable of communication with the communication unit, with a first access point capable of communication in the first frequency band being presented differently from a second access point capable of communication in the second frequency band. This can make an occupant of the mobile object recognize that there is a second access point capable of communication connection in the second frequency band that does not overlap with the first frequency band in which communication with the communication terminal is being performed, thereby encouraging the occupant to perform communication with the second access point in the second frequency band to prevent the communication with the communication terminal from being interrupted by connection with an access point during the communication with the communication terminal.

(Configuration 2) The communication device according to configuration 1, wherein the communication control unit is further configured to display the access point information image on the display device when the communication between the communication unit and the communication terminal is performed in the first frequency band and the communication control unit recognizes an operation to connect the communication unit and the access points by an occupant of the mobile object.

With the communication device in configuration 2, by displaying the access point information image on the display device at the timing of the occupant of the mobile object performing an operation to connect to an access point, information on the second access point capable of connection in the second frequency band that does not overlap with the first frequency band used for communication with the communication terminal can be effectively provided to the occupant of the mobile object.

(Configuration 3) The communication device according to configuration 1 or configuration 2, wherein the communication control unit is further configured to interrupt the communication between the communication unit and the communication terminal in the first frequency band when the communication between the communication unit and the communication terminal is performed in the first frequency band and the communication control unit recognizes an operation to connect the communication unit and the access points by an occupant of the mobile object, and the access point detection unit is further configured to detect the access points capable of communication connection with the communication unit by performing communication in the first frequency band and the second frequency band while the communication between the communication unit and the communication terminal is interrupted.

With the communication device in configuration 3, the communication between the communication unit and the communication terminal can be interrupted, and the access point detection unit can perform a search in the first frequency band and the second frequency band to recognize access points capable of connection with the communication unit.

(Configuration 4) The communication device according to configuration 3, wherein the communication control unit is further configured to start communication between the communication unit and the second access point in the second frequency band and resume the communication between the communication unit and the communication terminal in the first frequency band when the communication control unit recognizes an operation to connect to the second access point by the occupant in response to display of the access point information image on the display device.

With the communication device in configuration 4, both communication between the communication unit and the communication terminal in the first frequency band and communication between the communication unit and the second access point in the second frequency band can be performed in response to an operation to connect to the second access point by the occupant.

(Configuration 5) The communication device according to any one of configurations 1 to 4, wherein the communication control unit is further configured to output a communication unavailability announcement that communication with the terminal device becomes unavailable from an announcement device used in the mobile object when the communication control unit recognizes an operation to connect to the first access point by an occupant of the mobile object in response to display of the access point information image on the display device.

With the communication device in configuration 5, by announcing to the occupant who performs an operation to connect to the first access point that the communication with the communication terminal becomes unavailable, the occupant can be encouraged to connect to the second access point to prevent the communication between the communication unit and the communication terminal from being interrupted.

(Configuration 6) The communication device according to any one of configurations 1 to 5, wherein the communication control unit is further configured to output a recommended frequency band announcement recommending connection with the second access point from an announcement device used in the mobile object when the communication control unit recognizes an operation to connect to the first access point by an occupant of the mobile object in response to display of the access point information image on the display device.

With the communication device in configuration 6, by announcement recommending the occupant who performs an operation to connect to the first access point to perform communication with communication terminal in the second frequency band, the occupant can be encouraged to continue the communication between the communication unit and the communication terminal by changing selection of the frequency band used for the communication between the communication unit and the communication terminal from the first frequency band to the second frequency band.

(Configuration 7) The communication device according to any one of configurations 1 to 6, wherein the communication control unit is further configured to display on the display device as the access point information image an image in which only information on the second access point is presented and information on the first access point is hidden.

With the communication device in configuration 7, by presenting only information on the second access point and hiding information on the first access point in the access point information image, the occupant can be encouraged to connect to the second access point to prevent the communication between the communication unit and the communication terminal from being interrupted due to overlap between the frequency bands used.

(Configuration 8) The communication device according to any one of configurations 1 to 6, wherein the communication control unit is further configured to display on the display device as the access point information image an image in which information on the second access point is presented preferentially over information on the first access point.

With the communication device in configuration 8, by presenting information on the second access point preferentially over information on the first access point in the access point information image, the occupant can be encouraged to connect to the second access point to prevent the communication between the communication unit and the communication terminal from being interrupted due to overlap between the frequency bands used.

(Configuration 9) The communication device according to any one of configurations 1 to 8, wherein the communication control unit is further configured to change a display style of the access point information image according to an operation to set the display style of the access point information image by an occupant of the mobile object.

With the communication device in configuration 9, the access point information image can be changed to a display style that suits the occupant's preference according to a setting operation by the occupant, thereby facilitating selection of an access point by the occupant.

(Configuration 10) A communication control method performed by a communication device used in a mobile object and including a communication unit configured to perform wireless communication with communication targets in a first frequency band or a second frequency band, the method including: an access point detection step of detecting access points capable of communication connection with the communication unit; and a communication control step of controlling communication between the communication unit and a communication terminal and communication between the communication unit and the access points, and displaying an access point information image on a display device used in the mobile object when the communication between the communication unit and the communication terminal is performed in the first frequency band, the access point information image presenting information on the access points detected in the access point detection step, with a first access point capable of communication connection in the first frequency band being presented differently from a second access point capable of communication connection in the second frequency band.

By performing the communication control method in configuration 10 by a communication device, the same effect as the communication device in configuration 1 can be achieved.

1 . . . communication device, 10 . . . processor, 11 . . . access point detection unit, 12 . . . communication control unit, 20 . . . memory, 21 . . . control program for communication device, 22 . . . smartphone-linked application program, 23 . . . assistant application program, 30 . . . communication unit, 40 . . . display device, 41 . . . on-board microphone, 42 . . . on-board speaker, 50 . . . smartphone (communication terminal), 70, 80. . . . AP list image, 71-73, 81-83. . . . AP information button, 75 . . . connection interruption announcement image, 100 . . . vehicle (mobile object), 200 . . . external AP, 210 . . . communication network, P . . . occupant.

1. A communication device used in a mobile object, comprising:
a communication unit configured to perform wireless communication with communication targets in a first frequency band or a second frequency band;
an access point detection unit configured to detect access points capable of communication connection with the communication unit; and
a communication control unit configured to control communication between the communication unit and a communication terminal and communication between the communication unit and the access points, and to display an access point information image on a display device used in the mobile object when the communication between the communication unit and the communication terminal is performed in the first frequency band, the access point information image presenting information on the access points detected by the access point detection unit, with a first access point capable of communication connection in the first frequency band being presented differently from a second access point capable of communication connection in the second frequency band.

2. The communication device according to claim 1, wherein the communication control unit is further configured to display the access point information image on the display device when the communication between the communication unit and the communication terminal is performed in the first frequency band and the communication control unit recognizes an operation to connect the communication unit and the access points by an occupant of the mobile object.

3. The communication device according to claim 1, wherein
the communication control unit is further configured to interrupt the communication between the communication unit and the communication terminal in the first frequency band when the communication between the communication unit and the communication terminal is performed in the first frequency band and the communication control unit recognizes an operation to connect the communication unit and the access points by an occupant of the mobile object, and
the access point detection unit is further configured to detect the access points capable of communication connection with the communication unit by performing communication in the first frequency band and the second frequency band while the communication between the communication unit and the communication terminal is interrupted.

4. The communication device according to claim 3, wherein the communication control unit is further configured to start communication between the communication unit and the second access point in the second frequency band and resume the communication between the communication unit and the communication terminal in the first frequency band when the communication control unit recognizes an operation to connect to the second access point by the occupant in response to display of the access point information image on the display device.

5. The communication device according to claim 1, wherein the communication control unit is further configured to output a communication unavailability announcement that communication with the terminal device becomes unavailable from an announcement device used in the mobile object when the communication control unit recognizes an operation to connect to the first access point by an occupant of the mobile object in response to display of the access point information image on the display device.

6. The communication device according to claim 1, wherein the communication control unit is further configured to output a recommended frequency band announcement recommending connection with the second access point from an announcement device used in the mobile object when the communication control unit recognizes an operation to connect to the first access point by an occupant of the mobile object in response to display of the access point information image on the display device.

7. The communication device according to claim 1, wherein the communication control unit is further configured to display on the display device as the access point information image an image in which only information on the second access point is presented and information on the first access point is hidden.

8. The communication device according to claim 1, wherein the communication control unit is further configured to display on the display device as the access point information image an image in which information on the second access point is presented preferentially over information on the first access point.

9. The communication device according to claim 1, wherein the communication control unit is further configured to change a display style of the access point information image according to an operation to set the display style of the access point information image by an occupant of the mobile object.

10. A communication control method performed by a communication device used in a mobile object and including a communication unit configured to perform wireless communication with communication targets in a first frequency band or a second frequency band, the method comprising:
an access point detection step of detecting access points capable of communication connection with the communication unit; and
a communication control step of controlling communication between the communication unit and a communication terminal and communication between the communication unit and the access points, and displaying an access point information image on a display device used in the mobile object when the communication between the communication unit and the communication terminal is performed in the first frequency band, the access point information image presenting information on the access points detected in the access point detection step, with a first access point capable of communication connection in the first frequency band being presented differently from a second access point capable of communication connection in the second frequency band.
